(19) United States
(12) Patent Application Publication
(10) Pub. No.: US 2009/0138657 A1
(43) Pub. Date: May 28, 2009

(54) DATA BACKUP SYSTEM FOR LOGICAL VOLUME MANAGER AND METHOD THEREOF

(75) Inventors: Jian-Zhong WANG, Tianjin (CN); Tom CHEN, Taipei (TW); Win-Harn LIU, Taipei (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: INVENTEC CORPORATION, Taipei (TW)

(21) Appl. No.: 11/945,132

(22) Filed: Nov. 26, 2007

(51) Int. Cl. G06F 12/16; G06F 12/08

(52) U.S. Cl. 711/118; 711/E12.103; 711/E12.017

(57) ABSTRACT

A data backup system for a logical volume manager (LVM) and a method thereof, capable of realizing data backup in the LVM having a battery backed cache memory (BBCM). The data backup system includes a physical storage device, a BBCM, an LVM, and a data backup function. The physical storage device is used to store data of the LVM. The BBCM is used to provide a plurality of index regions and a plurality of data regions. The LVM is used to manage data save position of the physical storage device. The data backup function is used to look up whether the BBCM saves the data to be backed up by the logical volume. If the BBCM has the data, the BBCM reads out the data to be backed up, and writes the data into a snapshot volume (SV).

### BACKGROUND OF THE INVENTION

1. Field of Invention

The present invention relates to a data backup system for a logical volume manager (LVM) and a method thereof. More particularly, the present invention relates to a data backup system for an LVM and a method thereof applying a battery backed cache memory (BBCM).

2. Related Art

In order to safely and effectively save digital data in computer, many digital data storing technologies have been proposed in the past, such as redundant array of independent disks (RAID), and logical volume manager (LVM). For the LVM, a plurality of physical disks is integrated to serve as a same volume group, and then the volume group is divided into several logical volumes (LV)

A snapshot method is further provided in the LVM. The so-called snapshot is to provide a corresponding snapshot volume (SV), and the snapshot volume SV is used to perform real-time backup on digital data of a certain specific time in the logical volume LV. The snapshot volume SV performs the backup on rewritten data in the logical volume LV instead of performing total backup on all the data in the logical volume LV.

For flow of the data backup of the logical volume and the snapshot volume, please refer to FIG. 1A. A logical volume is provided (step S010), and the logical volume respectively has a plurality of data. A snapshot volume is newly added at fixed intervals (step S020). New data is written into a cache memory (step S030). The data to be backed up in the logical volume is read (step S040). The data to be backed up is written into the snapshot volume (step S050). The new data is written from the cache memory into the logical volume (step S060).

In order to clearly illustrate operation manner of the logical volume and the snapshot volume, please refer to FIGS. 1B-1E. Firstly, a logical volume LV110 is created. In order to be convenient to illustrate mapping relation of the logical volume LV110 and the snapshot volume SV, here it is assumed that four groups of data, namely Data1₁ 1111, Data2₁ 1121, Data3₁ 1131, Data4₁ 1141, are saved in the logical volume LV110. Each parameter in the Data Nₓ represents the x^{th} backup of the N^{th} Data in the logical volume LV110.

Next, a first snapshot volume SV₁ 120 is created. At this time, the logical volume LV110 does not have modification of data, so the first snapshot volume SV₁ 120 does not store the modification data of the logical volume LV110, as shown in FIG. 1B. The Data1₁ 1111 and the Data4₁ 1141 in the logical volume LV110 are rewritten into Data1₂ 1112 and Data4₂ 1142. At the same time, the first snapshot volume SV₁ 120 respectively stores the Data1₁ 1111 and the Data4₁ 1141, as shown in FIG. 1c. In order to clearly illustrate the dependent position, please refer to arrow indication direction of each block data in the drawings.

A second snapshot volume SV₂ 130 is newly added, please refer to FIG. 1D, the manner of newly adding the snapshot volume is performing an action of newly adding the snapshot volume at fixed intervals. Next, the Data2₁ 1121 and the Data4₂ 1142 in the logical volume LV110 are rewritten, and then the modification data of the Data2₁ 1121 and the Data4₂ 1142 in the logical volume LV110 is recorded to the second snapshot volume SV₂ 130, as shown in FIG. 1E.

In other words, the snapshot recording method of the LVM is that when the logical volume LV110 has the data transaction, the original data before the transaction of the logical volume LV110 is stored to the latest snapshot volume SV. However, the backup flow needs the following steps: reading old data of the logical volume; writing the old data into the snapshot volume; and writing new data into the logical volume. The method needs disk actions of reading once and writing twice. When a great quantity of data needs to be accessed, executing performance of the LVM is made to be encumbered by frequent operation of the disk actions.

### SUMMARY OF THE INVENTION

In view of the above problem, the present invention is mainly directed to provide a data backup system for an LVM. A BBCM is applied to the data backup system for the LVM, so as to increase the speed creating snapshot volumes in the LVM.

In order to achieve the above objective, the data backup system for the LVM provided by the present invention includes a physical storage device, a BBCM, an LVM, and a data backup means. The physical storage device is used to store data of the LVM. The BBCM is used to provide a plurality of index regions and a plurality of data regions. The LVM is used to manage data save positions of the physical storage device. The data backup means is used to look up whether the BBCM saves the data to be backed up by the logical volume. If the BBCM has the data, the BBCM reads out the data to be backed up, and writes the data into the snapshot volume.

In another aspect of the present invention, the present invention provides a data backup method for an LVM. The data backup method for the LVM includes the following steps: creating a snapshot volume; looking up whether the BBCM saves record data; and writing the record data from the BBCM to the snapshot volume if the BBCM saves the record data.

In the present invention, the BBCM is applied to the LVM for data writing when creating snapshot volumes, so as to increase the data writing speed when creating the snapshot volumes.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1A is a schematic view of the process of the conventional data backup;

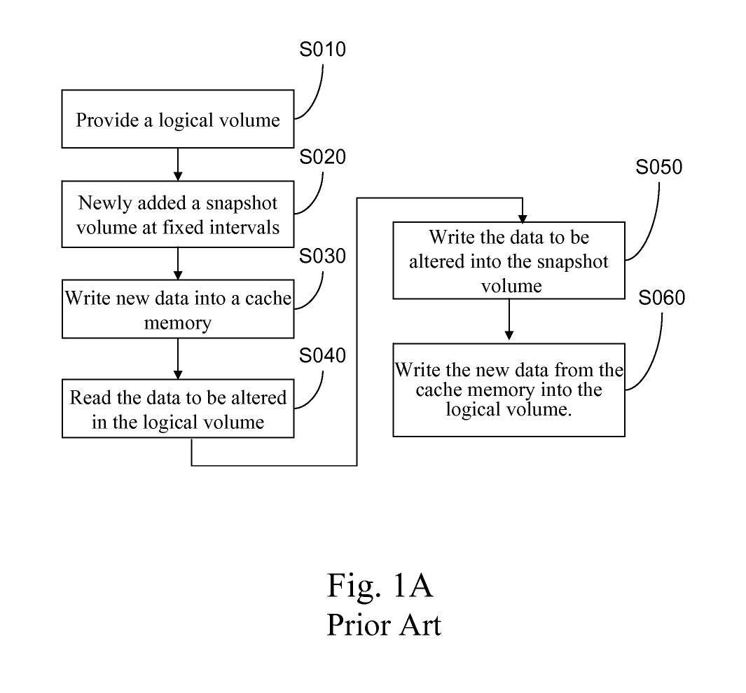

FIG. 1B is a schematic view of generating the first snapshot volume in the conventional art;

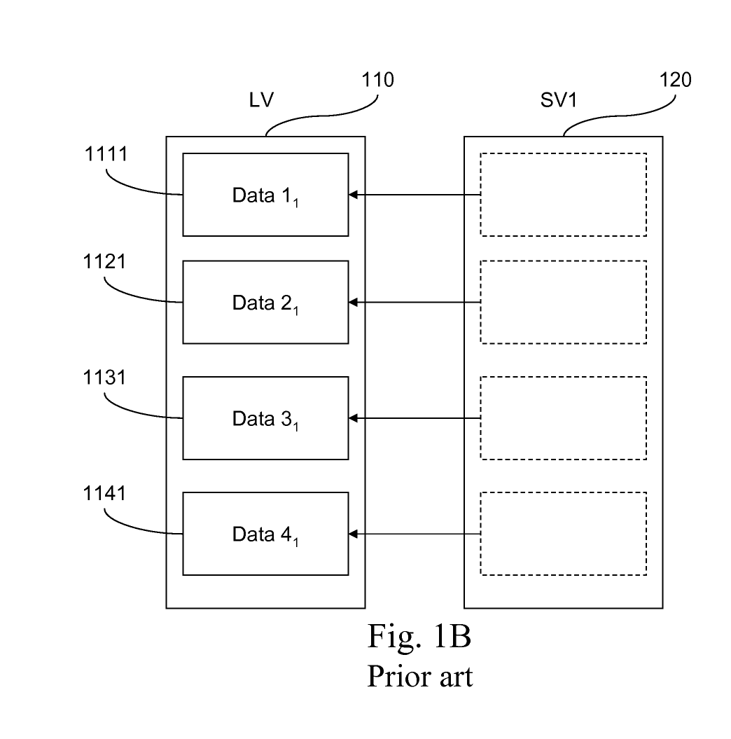

FIG. 1C is a schematic view of the data backup performed by the first snapshot volume in the conventional art;

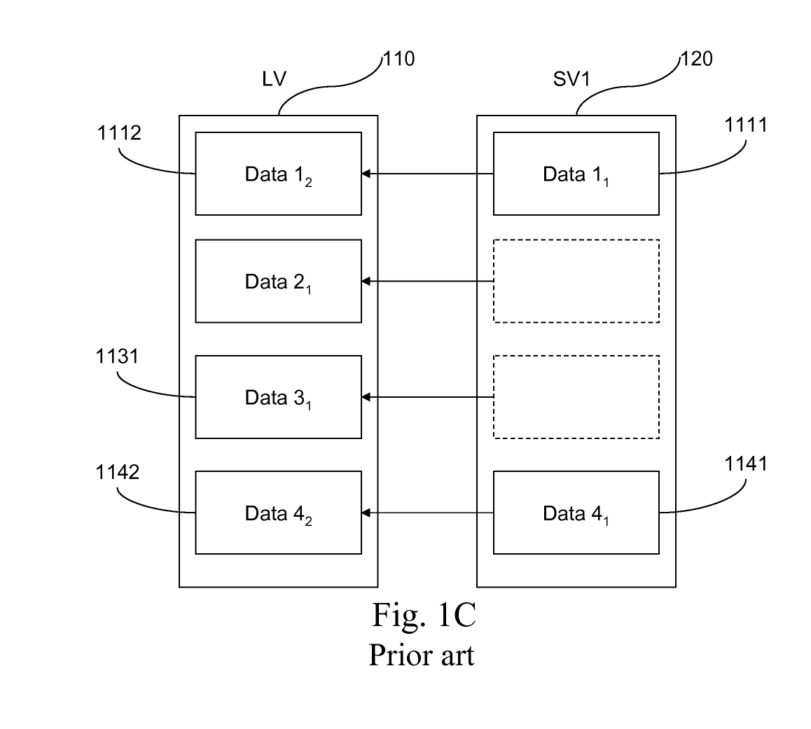

FIG. 1D is a schematic view of generating the second snapshot volume in the conventional art;

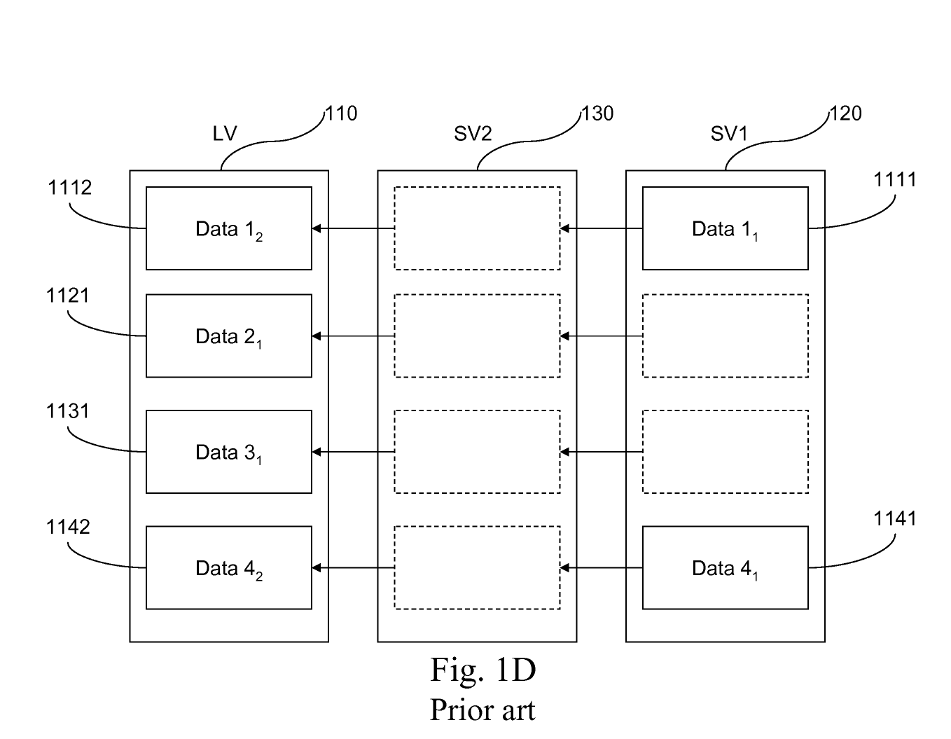

FIG. 1E is a schematic view of the data backup performed by the second snapshot volume in the conventional art;

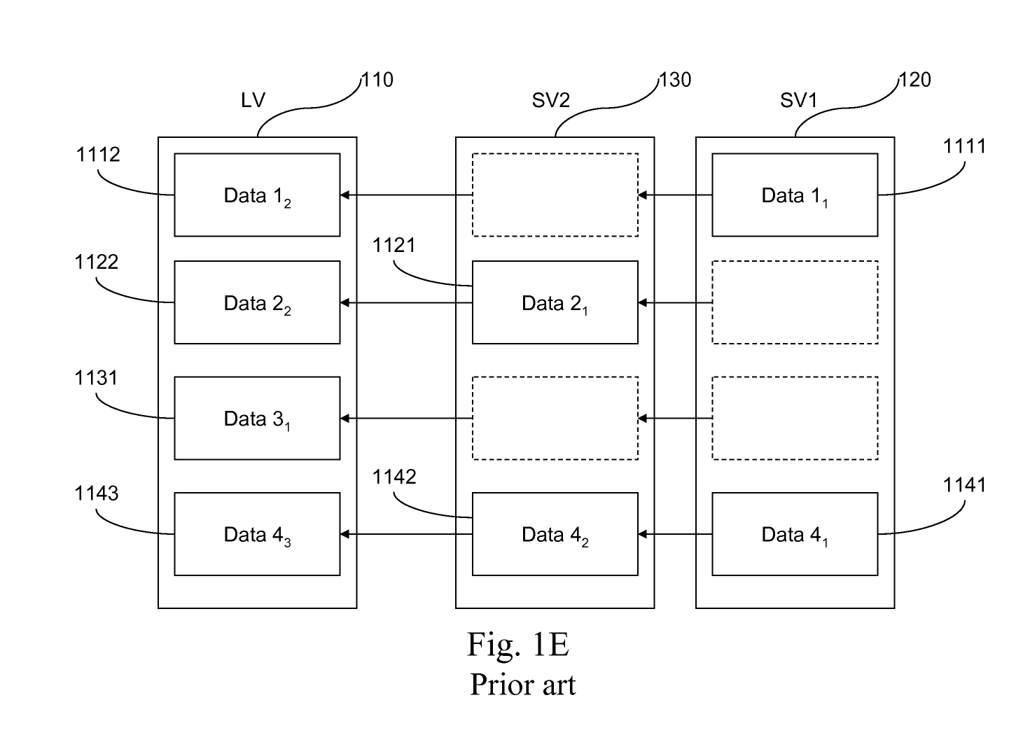

FIG. 2 is an architecture view of the system of the present invention; and

FIG. 3 is a flow chart of the operation of the present invention.

### DETAILED DESCRIPTION OF THE INVENTION

In the present invention, a BBCM is applied into an LVM for the creation of snapshot volumes.

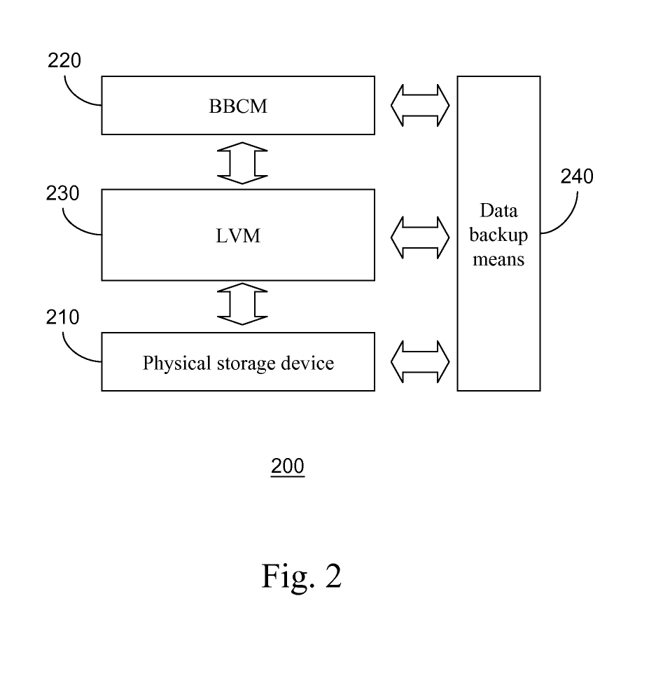

Referring to FIG. 2, an architecture view of the system of the present invention is shown. In a data backup system for an LVM 200 provided by the present invention, the data backup system 200 includes a physical storage device 210, a BBCM 220, an LVM 230, and a data backup means 240. The physical storage device 210 is used to store data of the LVM 230. When accident occurs in the computer, the BBCM 220 uses a battery to protect data in the cache memory, thereby providing data completeness. After the computer is rebooted, the computer can use the data saved in the BBCM 220 to resume the data before the occurrence of the accident.

Generally, the BBCM 220 is mainly divided into two parts, namely index regions and data regions. The index regions are used to record position of each data in the data regions, and the data regions are memories for saving the data. When the computer intends to look up the data, firstly an index value of each data in the data regions is looked up from the index regions, and then the data at the position is got according to the looked-up index value, in which the method of looking up the data from the cache memory can be direct mapping, full associative mapping, or set associative mapping. The BBCM 220 protects the data of the index regions and the data regions, thereby avoiding the data in the cache memory from being lost when the accidental situation occurs in the computer.

When new data is written into the cache memory, an index value corresponding to the data is creased in the index region first. When the data saved in the data region is deleted, the index value of the data in the index region is cleared. The LVM 230 is used to manage data save position of the physical storage device 210. The data backup means 240 is used to look up whether the BBCM 220 saves the data to be backed up by the logical volume. If the BBCM 220 saves the data, the BBCM 220 reads out the data to be backed up, and writes the data into the snapshot volume.

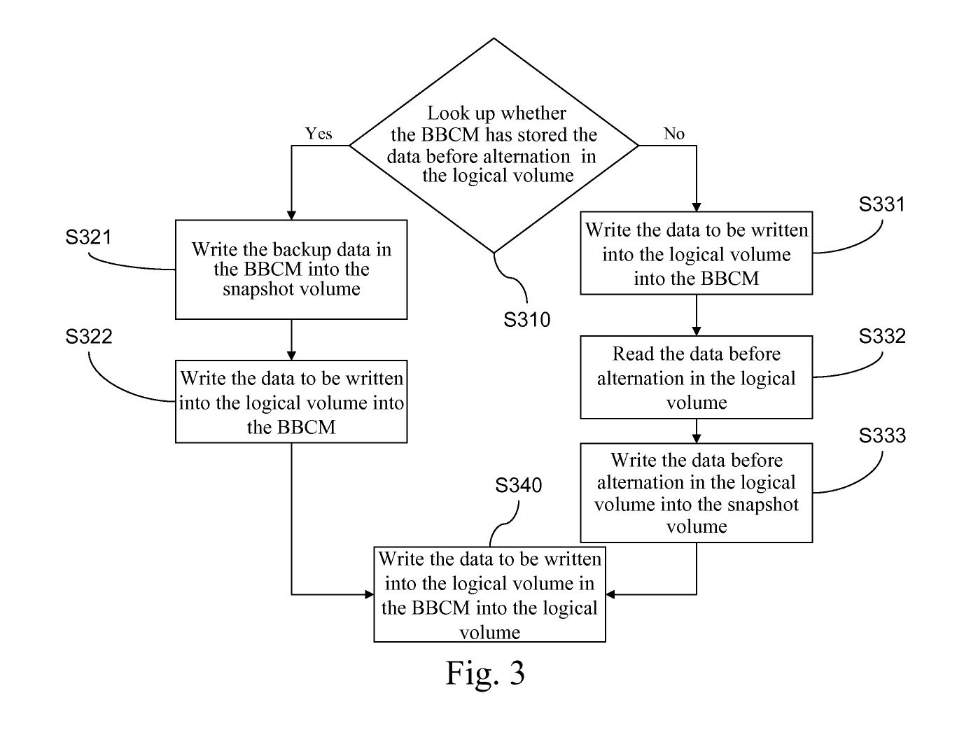

Referring to FIG. 3, a flow chart of the operation of the present invention is shown. It is looked up whether the BBCM has stored the data to be backed up by the logical volume (step S310). If the BBCM has stored the data to be backed up in the logical volume, the backup data in the BBCM is written into the snapshot volume (step S321). The data to be written into the logical volume is written in to the BBCM (step S322). The data to be written into the logical volume in the BBCM is written in to the logical volume (step S340). If the BBCM does not store the data to be backed up in the logical volume, the data to be written into the logical volume is written into the BBCM (step S331). The data to be backed up in the logical volume is read (step S332). The data to be backed up in the logical volume is written into the snapshot volume (step S333). The data to be written into the logical volume in the BBCM is written into the logical volume (step S340).

In the present invention, it is determined whether the BBCM 220 saves the data to be backed up in the logical volume, thereby reducing one time of reading action performed on the logical volume. Therefore, when the data is copied to the snapshot volume, it is only necessary to perform one time of data writing action on the logical volume and to perform one time of writing action on the snapshot volume.

In the present invention, the BBCM 220 is applied to the LVM 230 for the data writing when creating snapshot volumes, thereby increasing the data writing speed when creating the snapshot volumes.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A data backup method for a logical volume manager (LVM), for backing up a certain record data in an LVM having a battery backed cache memory (BBCM), comprising:
creating a snapshot volume;
looking up the record data to be backed up in the BBCM;
directly writing the record data saved in the BBCM from the BBCM to the snapshot volume; and
writing residual data to be backed up in the logical volume to the snapshot volume.

2. The data backup method for an LVM as claimed in claim 1, wherein getting the record data from the BBCM to write into the snapshot volume further comprises:
looking up index regions of the BBCM; and
looking up data regions of the BBCM according to the index regions of the BBCM.

3. The data backup method for an LVM as claimed in claim 1, further comprising:
getting the record data to be backed up from the logical volume to write into the snapshot volume, if the BBCM does not have the record data.

4. A data backup system for an LVM, applied to an LVM, wherein the LVM has a logical volume and a snapshot volume, when the data in the logical volume is modified, the data to be backed up is saved in the currently generated snapshot volume, the data backup system comprising:
a physical storage device, for storing data;
a BBCM, for providing a plurality of index regions and a plurality of data regions, wherein each index region records each data block in the data regions; and
an LVM, for managing data save positions of the physical storage device and executing a data backup means, wherein the data backup means is used to look up whether the BBCM saves the data to be backed up by the logical volume, if the BBCM has the data, the BBCM reads out the data to be backed up, writes the data into the snapshot volume, and overwrites the data to be backed up to be new data.

5. The data backup method for an LVM as claimed in claim 4, further comprising an operation unit, for executing the operation of the LVM and accessing the data blocks in the data regions according to the index regions of the BBCM, wherein the operation unit determines whether the data is written into the physical storage device according to the recorded data blocks.
